(19) United States
(12) Patent Application Publication
(10) Pub. No.: US 2026/0246316 A1
(43) Pub. Date: Aug. 20, 2026

(54) MOTOR

(71) Applicant: MINEBEA MITSUMI Inc., Kitasaku-gun, Nagano (JP)

(72) Inventors: Shintaro NAKAMURA, Kitasaku-gun, Nagano (JP); Kentaro HANASHIMA, Kitasaku-gun, Nagano (JP); Yasuhiro MINEMATSU, Kitasaku-gun, Nagano (JP); Kaiki OGATA, Kitasaku-gun, Nagano (JP)

(21) Appl. No.: 19/161,804

(22) PCT Filed: Mar. 1, 2024
(86) PCT No.: PCT/JP2024/007674

§ 371 Date: Sep. 3, 2025

(30) Foreign Application Priority Data
Mar. 7, 2023 (JP) 2023-034321
Aug. 8, 2023 (JP) 2023-129165

(51) Int. Cl. H02K 1/16

(52) U.S. Cl. CPC H02K 1/16

(57) ABSTRACT

A motor includes a rotor and a first stator and a second stator overlapping in a direction of a rotation axis X of the rotor. The first stator and the second stator include a first coil group forming a first phase. In the first coil group, a portion included in the first stator is electrically connected in series to a portion included in the second stator.

### TECHNICAL FIELD

The present invention relates to a motor.

### BACKGROUND ART

In a typical motor, a coil is wound around teeth of a stator core (for example, Patent Document 1). To increase an output of a motor and reduce the size of the motor, an increasing the number of teeth of a stator core and improving winding density (space factor) may be required. However, increasing the number of teeth while maintaining the size of the stator core reduces the distance between adjacent teeth, thus makes winding operation difficult, and makes it difficult to improve the space factor.

As a method of facilitating the winding operation, for example, reducing a circumferential dimension of a tip of each tooth and increasing a distance (slot opening) between the tips of adjacent teeth is conceivable. In this case, however, the slot opening may be larger than an ideal value for obtaining sufficient motor characteristics.

### CITATION LIST

### Patent Literature

Patent Document 1: WO 2009/060600

### SUMMARY OF INVENTION

### Technical Problem

An object of the present invention is to provide a motor with a winding to be easily applied.

### Solution to Problem

A motor as one example of the present invention includes: a rotor; and a first stator and a second stator overlapping in a rotation axis direction of the rotor. The first stator and the second stator include a first coil group forming a first phase. In the first coil group, a portion included in the first stator is electrically connected in series to a portion included in the second stator.

### BRIEF DESCRIPTION OF DRAWINGS

FIG. 1 is a plan view of a stator of a motor according to a first embodiment as one example of the present invention.

FIG. 2 is a connection diagram of the motor according to first to third embodiments as examples of the present invention.

FIG. 3 is an exploded perspective view of a stator of the motor according to the first embodiment as one example of the present invention.

FIG. 4 is a perspective view of the stator of the motor according to the first embodiment as one example of the present invention.

FIG. 5 is an enlarged exploded perspective view of the stator of the motor according to the first embodiment as one example of the present invention.

FIG. 6 is an enlarged plan view of the stator of the motor according to the first embodiment as one example of the present invention.

FIG. 7 is a schematic diagram of a first coil group of the motor according to the first embodiment as one example of the present invention.

FIG. 8 is a schematic diagram of first to third coil groups of the motor according to the first embodiment as one example of the present invention.

FIG. 9 is a schematic diagram of first to third coil groups of the motor according to the second embodiment as one example of the present invention.

FIG. 10 is an exploded perspective view of a stator of the motor according to the third embodiment as one example of the present invention.

FIG. 11 is a schematic diagram of first to third coil groups of the motor according to the third embodiment as one example of the present invention.

FIG. 12 is a connection diagram in a case of electrically connecting a portion included in a first stator in parallel to a portion included in a second stator in each coil group in the motor according to the first to third embodiments as examples of the present invention.

### DESCRIPTION OF EMBODIMENTS

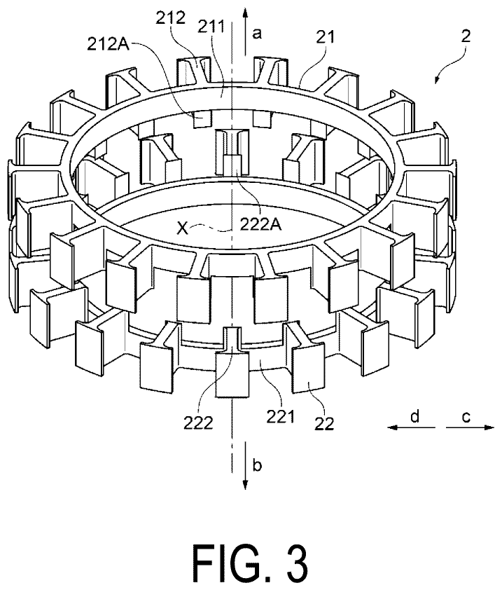

In the description of embodiments of the present invention, a direction along a rotation axis X of a rotor (rotation axis direction) is simply referred to as an axial direction for convenience of description. In the axial direction, a direction of arrow a in FIGS. 3, 4, and 10 is referred to as one side, and a direction of arrow b as a direction opposite to the direction of arrow a is referred to as the other side. In a plane orthogonal to the rotation axis X, a direction toward and away from the rotation axis X is referred to as a radial direction. In the radial direction, an arrow c direction (outer side) away from the rotation axis X is referred to as one side, and an arrow d direction (inner side) approaching the rotation axis X is referred to as the other side. A direction of rotation about the rotation axis X is referred to as a circumferential direction.

### First Embodiment

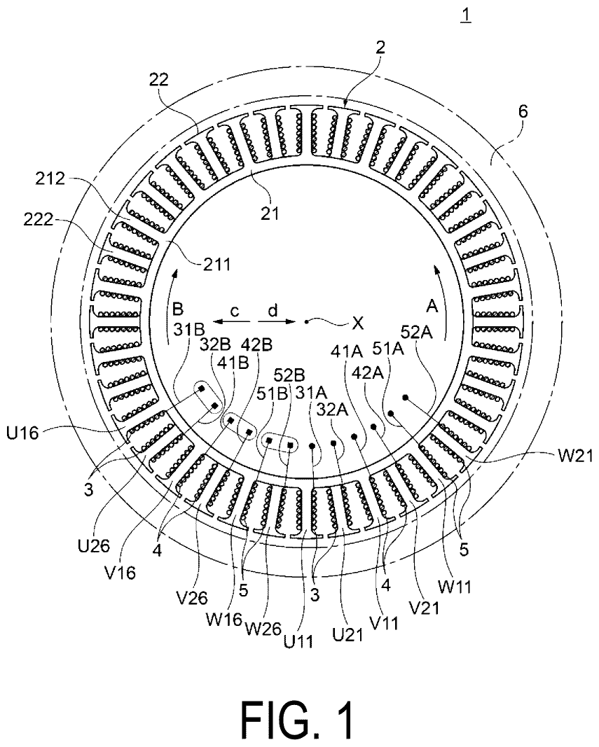

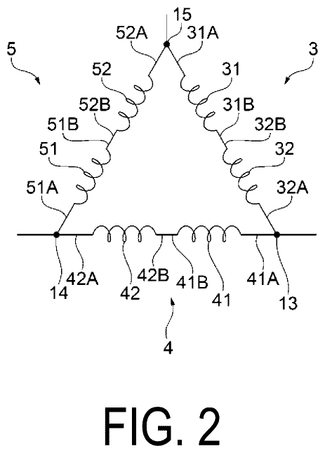

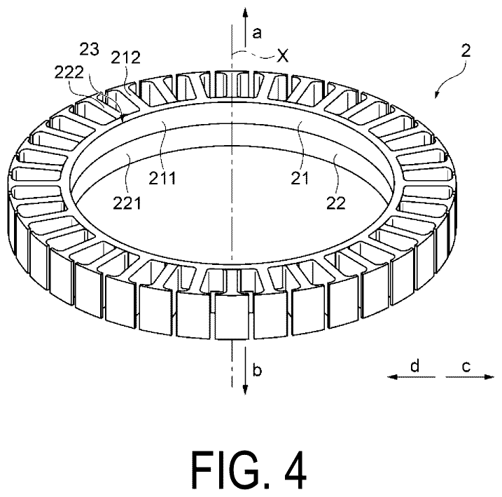

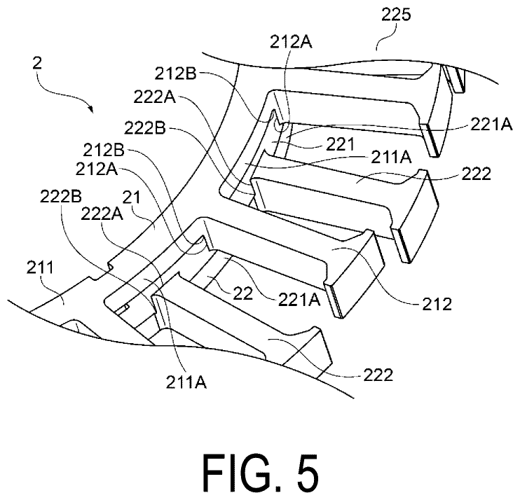

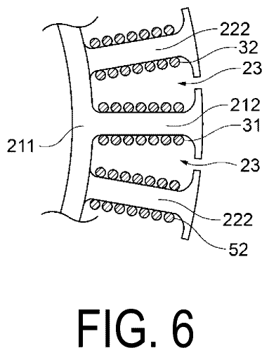

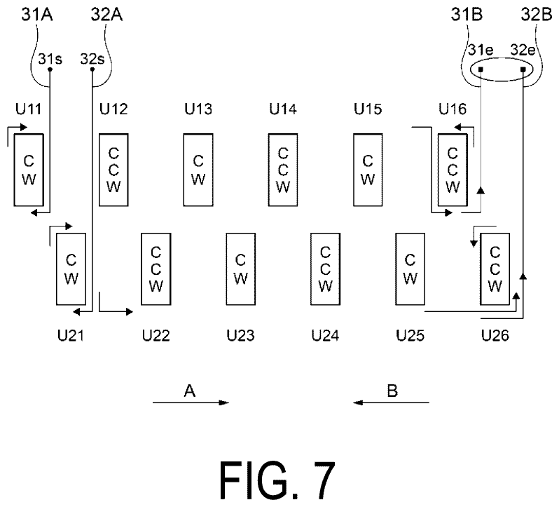

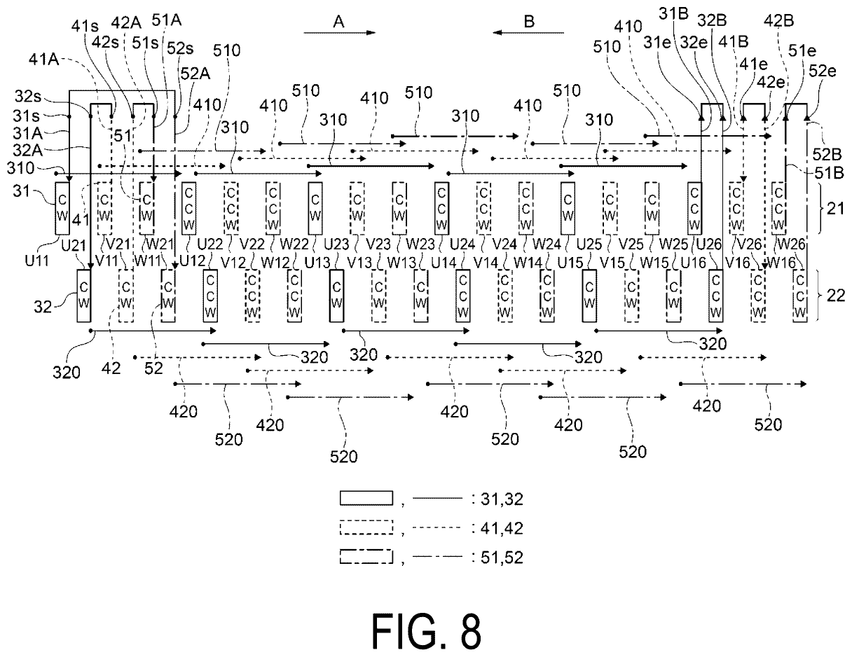

A first embodiment as one example of the present invention will be described below with reference to the drawings. FIG. 1 is a plan view of a stator 2 of a motor 1 according to the present embodiment, FIG. 2 is a connection diagram of the motor 1, FIG. 3 is an exploded perspective view of the stator 2, FIG. 4 is a perspective view of the stator 2, FIG. 5 is an enlarged exploded perspective view of the stator 2, FIG. 6 is an enlarged plan view of the stator 2, FIG. 7 is a schematic view of a first coil group 3 of the motor 1, and FIG. 8 is a schematic view of the first coil group 3, a second coil group 4, and a third coil group 5 of the motor 1. However, FIGS. 3 to 5 omit each coil group.

As illustrated in FIG. 1, the motor 1 according to the present embodiment is an outer-rotor type three-phase brushless DC motor including the stator 2, the first coil group 3, the second coil group 4, the third coil group 5, and the rotor 6. As illustrated in FIG. 2, in the motor 1, the first coil group 3 forming a first phase (U phase), the second coil group 4 forming a second layer (V phase), and the third coil group 5 forming a third phase (W phase) form a delta connection.

Specifically, the first coil group 3 and the second coil group 4 are connected to each other at a contact 13, the second coil group 4 and the third coil group 5 are connected to each other at a contact 14, and the third coil group 5 and the first coil group 3 are connected to each other at a contact 15. A control device (not illustrated) is electrically connected to contacts 13, 14, and 15 of the delta connection. A DC power supply is electrically connected to two of the contacts 13, 14, and 15, and the connection being sequentially switched causes each coil group to be periodically excited, causing the rotor 6 including the permanent magnets to rotate. In the present embodiment, the number of magnetic poles of the permanent magnets in the rotor 6 is, for example, forty-two. However, the rotor 6 may have another number of magnetic poles.

The first coil group 3 includes a portion 31 included in a first stator 21 described later and a portion 32 included in a second stator 22 described later. In the first coil group 3, the portion 31 included in the first stator 21 is electrically connected in series to the portion 32 included in the second stator 22. The second coil group 4 includes a portion 41 included in the first stator 21 and a portion 42 included in the second stator 22. In the second coil group 4, the portion 41 included in the first stator 21 is electrically connected in series to the portion 42 included in the second stator 22. The third coil group 5 includes a portion 51 included in the first stator 21 and a portion 52 included in the second stator 22. In the third coil group 5, the portion 51 included in the first stator 21 is electrically connected in series to the portion 52 included in the second stator 22.

As illustrated in FIGS. 3 and 4, the stator 2 includes the first stator 21 and the second stator 22 formed separately from each other. Each of the first stator 21 and the second stator 22 may be formed by laminating thin plate-shaped magnetic bodies, or may be formed by a single massive member.

The first stator 21 and the second stator 22 overlap in the axial direction of the rotor. In the axial direction, the first stator 21 is arranged on one side (in the direction of arrow a), and the second stator 22 is arranged on the other side (in the direction of arrow b). The first stator 21 and the second stator 22 have a common shape.

The first stator 21 includes an annular yoke (annular part) 211 and a plurality of (eighteen in the present embodiment) teeth (magnetic pole parts) 212 extending from the yoke 211 to one side in the radial direction (the direction of arrow c) and having a T-shaped cross-sectional shape. The second stator 22 includes an annular yoke (annular part) 221 and a plurality of (eighteen in the present embodiment) teeth (magnetic pole parts) 222 extending from the yoke 221 to one side in the radial direction (the direction of arrow c) and having a T-shaped cross-sectional shape. The number of teeth 212 or 222 is not limited to 18 but is a multiple of 3 when the motor 1 is a three-phase brushless DC motor.

In the first stator 21, one side (the direction of arrow a) in the axial direction of an end part on the other side (the direction of arrow d) in the radial direction of the teeth 212 is connected to an outer circumferential surface (a circumferential surface on one side (the direction of arrow c) in the radial direction) of the yoke 211. In the axial direction, the teeth 212 protrude to the other side of the yoke 211 (in the direction of arrow b).

In the second stator 22, the other side (the direction of arrow b) in the axial direction of the end part on the other side (the direction of arrow d) in the radial direction of the teeth 222 is connected to the outer circumferential surface (the circumferential surface on the one side (the direction of arrow c) in the radial direction) of the yoke 221. In the axial direction, the teeth 222 protrude toward one side (the direction of arrow a) of the yoke 221.

In the axial direction, the dimension (thickness) of each of the yokes 211 or 221 is substantially half the dimension (thickness) of each of the teeth 212 or 222. Therefore, substantially half of the teeth 212 or 222 are supported by the yokes 211 or 221 in the axial direction.

As illustrated in FIG. 5, a portion 212A on the other side (the direction of arrow b) in the axial direction of the end part on the other side (the direction of arrow d) in the radial direction of the teeth 212 is not supported by the yoke 211 and is exposed to the other side (the direction of arrow b) in the radial direction. Similarly, a portion 222A on one side in the axial direction (the direction of arrow a) of an end part on the other side in the radial direction (the direction of arrow d) of the teeth 222 is exposed to the other side (the direction of arrow b) in the radial direction without being supported by the yoke 221. Therefore, step portions 212B and 222B are formed between the teeth 212 or 222 and the yokes 211 or 221.

The first stator 21 and the second stator 22 are assembled such that the yoke 211 of the first stator 21 and the yoke 221 of the second stator 22 overlap in the axial direction, thereby integrally forming the stator 2. The first stator 21 and the second stator 22 are assembled such that the teeth 212 and the teeth 222 are adjacent to each other (alternated) in the circumferential direction.

In the stator 2, a portion 222A of the teeth 222 of the second stator 22 is opposed to a portion 211A between two adjacent teeth 212 on an outer circumferential surface (a circumferential surface on one side in the radial direction (the direction of the arrow c)) of the yoke 211 of the first stator 21. Similarly, in the stator 2, a portion 221 A of the teeth 212 of the first stator 21 is opposed to a portion 212A between two adjacent teeth 222 in an outer circumferential surface (a circumferential surface on one side in the radial direction (the direction of the arrow c)) of the yoke 221 of the second stator 22.

As illustrated in FIG. 6, with the first stator 21 and the second stator 22 assembled and integrated to form the stator 2, a space 23 with wires forming each coil group arranged is formed between the adjacent teeth 212 and 222. The wire is wound around the teeth 212 or 222 via an insulator (not illustrated) in the space 23.

Of the plurality of teeth 212 of the first stator 21, any tooth is defined as a first tooth, a tooth adjacent to the first tooth in a first direction (counterclockwise direction in FIG. 1) A in the circumferential direction is defined as a second tooth, and the number of the teeth increases toward the first direction A. Similarly, any tooth of the plurality of teeth 222 of the second stator 22 is defined as a first tooth, a tooth adjacent to the first tooth in the first direction A in the circumferential direction is defined as a second tooth, and the number of the tooth increases toward the first direction A. With the first stator 21 and the second stator 22 assembled, it is assumed that the first tooth of the second stator 22 is adjacent to the first tooth of the first stator 21 in the first direction A.

Hereinafter, for the sake of simplicity, of the plurality of teeth 212 of the first stator 21, the first tooth is defined as U11, the fourth tooth as U12, the seventh tooth as U13, the tenth tooth as U14, the thirteenth tooth as U15, and the sixteenth tooth as U16. The second tooth of the first stator 21 is defined as V11, the fifth tooth as V12, the eighth tooth as V13, the eleventh tooth as V14, the fourteenth tooth as V15, and the seventeenth tooth as V16. The third tooth of the first stator 21 is defined as W11, the sixth tooth as W12, the ninth tooth as W13, the twelfth tooth as W14, the fifteenth tooth as W15, and the eighteenth tooth as W16. That is, from the first tooth of the first stator 21 toward the first direction A, these teeth are defined as U11, V11, W11, U12, V12, W12, U13, V13, W13, . . . , U16, V16, and W16. In the first stator 21, the tooth adjacent to W16 in the first direction A is U11.

Similarly, of the plurality of teeth 222 of the second stator 22, the first tooth is defined as U21, the fourth tooth as U22, the seventh tooth as U23, the tenth tooth as U24, the thirteenth tooth as U25, and the sixteenth tooth as U26. The second tooth of the second stator 22 is defined as V21, the fifth tooth as V22, the eighth tooth as V23, the eleventh tooth as V24, the fourteenth tooth as V25, and the seventeenth tooth as V26. The third tooth of the second stator 22 is defined as W21, the sixth tooth as W22, the ninth tooth as W23, the twelfth tooth as W24, the fifteenth tooth as W25, and the eighteenth tooth as W26. That is, from the first tooth of the second stator 22 toward the first direction A, these teeth are defined as U21, V21, W21, U22, V22, W22, U23, V23, W23, . . . , U26, V26, and W26. In the second stator 22, the tooth adjacent to W26 in the first direction A is U21.

The first coil group 3 forming the first phase (U phase) is wound around U11, U12, U13, U14, U15, and U16 of the plurality of teeth 212 of the first stator 21, and around U21, U22, U23, U24, U25, and U26 of the plurality of teeth 222 of the second stator 22. The second coil group 4 forming the second phase (V phase) is wound around V11, V12, V13, V14, V15, and V16 of the plurality of teeth 212 of the first stator 21, and V21, V22, V23, V24, V25, and V26 of the multiple teeth 222 of the second stator 22. The third coil group 5 forming the third phase (W phase) is wound around W11, W12, W13, W14, W15, and W16 of the plurality of teeth 212 of the first stator 21, and around W21, W22, W23, W24, W25, and W26 of the plurality of teeth 222 of the second stator 22. Windings are applied to the first stator 21 and the second stator 22 with the first stator 21 and the second stator 22 unassembled (separated). Hereinafter, a method of winding the first stator 21 and the second stator 22 will be described in detail by mainly taking the first coil group 3 as an example.

The first coil group 3 includes the portion 31 included in the first stator 21 and the portion 32 included in the second stator 22. The portion 31 included in the first coil group 3 included in the first stator 21 is formed by winding one wire in the order of U11, U12, U13, U14, U15 and U16 and is composed of a plurality of coils electrically connected in series and a connecting wire 310 connecting the coils to each other. The portion 32 of the first coil group 3 included in the second stator 22 is formed by winding one wire in the order of U21, U22, U23, U24, U25, and U26 and is composed of a plurality of coils electrically connected in series and the connecting wire 320 connecting the coils.

FIG. 7 is a schematic view illustrating the first stator 21 and the second stator 22 developed on a plane when viewed from the other side in the radial direction (inner side, arrow d direction). FIG. 7 illustrates only U11, U12, U13, U14, U15, and U16 of the plurality of teeth 212 of the first stator 21, and U21, U22, U23, U24, U25, and U26 of the plurality of teeth 222 of the second stator 22. That is, FIG. 7 illustrates only the teeth wound around with the wire to form the first coil group 3 among the plurality of teeth 212 of the first stator 21 and the plurality of teeth 222 of the second stator 22. In FIG. 7, arrows indicate winding directions of a wire and are unrelated to a direction of a current flow. In FIG. 7, some of the wires are omitted.

In the first coil group 3, the portion 31 included in the first stator 21 is formed as follows. First, in the vicinity of U11, the winding is started from a winding start part 31A, and the wire is wound around U11 clockwise (cw) to form a coil. In the present specification, the terms “clockwise (cw)” and “counterclockwise (ccw)” mean the winding direction as viewed from the other side in the radial direction (the inner side, the direction of arrow d).

Next, the connecting wire 310 (see FIG. 8) is formed on one side (the side opposite to the second stator 22) of the first stator 21 in the axial direction, and the wire is wound around U12 counterclockwise (ccw) to form a coil. Thereafter, similarly, the wire is wound around U13, U14, U15, and U16 in this order while alternately repeating clockwise (cw) and counterclockwise (ccw) to form each coil and reaches the winding end part 31B in the vicinity of U16. The winding start part 31A and the winding end part 31B of the wire are drawn out to one side in the axial direction of the stator 2.

In the first coil group 3, the portion 32 included in the second stator 22 is formed as follows. First, in the vicinity of U21, the winding is started from the winding start part 32A, and the wire is wound around U21 clockwise (cw) to form a coil. Next, the connecting wire 320 (see FIG. 8) is formed on the other side (the side opposite to the first stator 21) of the second stator 22 in the axial direction, and the wire is wound around U22 counterclockwise (ccw) to form a coil. Thereafter, similarly, the wire is wound around U23, U24, U25, and U26 in this order while alternately repeating clockwise (cw) and counterclockwise (ccw) to form each coil and reaches the winding end part 32B in the vicinity of U26. The winding start part 32A and the winding end part 32B of the wire are drawn out to one side in the axial direction of the stator 2.

In the first coil group 3, the winding end part 31B of the portion 31 included in the first stator 21 is connected to the winding end part 32B of the portion 32 included in the second stator 22. That is, in the first coil group 3, an end part 31e on the winding end side of the portion 31 included in the first stator 21 is electrically connected to an end part 32e on the winding end side of the portion 32 included in the second stator 22. Thus, in the first coil group 3, the portion 31 included in the first stator 21 is electrically connected in series to the portion 32 included in the second stator 22. Therefore, in the first coil group 3, a direction of a current flow to the portion 31 included in the first stator 21 is opposite to a direction of a current flow to the portion 32 included in the second stator 22 in the circumferential direction.

As illustrated in FIG. 8, the second coil group 4 and the third coil group 5 are formed according to the method of forming the first coil group 3 described above. That is, in the present embodiment, the first coil group 3, the second coil group 4, and the third coil group 5 are formed by winding the wire around the plurality of teeth 212 or 222 in this order toward the first direction A in the circumferential direction.

The second coil group 4 includes a portion 41 included in the first stator 21 and a portion 42 included in the second stator 22. The portion 41 of the second coil group 4 included in the first stator 21 is formed by winding one wire in the order of V11, V12, V13, V14, V15, and V16 and is composed of a plurality of coils electrically connected in series and a connecting wire 410 connecting the coils. The portion 42 included in the second stator 22 in the second coil group 4 is formed by winding one wire in the order of V21, V22, V23, V24, V25, and V26 and is composed of a plurality of coils electrically connected in series and a connecting wire 420 connecting the coils to each other.

The portion 41 of the second coil group 4 included in the first stator 21 is formed as follows. First, in the vicinity of V11, the winding is started from a winding start part 41A, and the wire is wound around V11 clockwise (cw) to form a coil. Next, the connecting wire 410 is formed on one side (the side opposite to the second stator 22) of the first stator 21 in the axial direction, and the wire is wound around V12 counterclockwise (ccw) to form a coil. Thereafter, similarly, the wire is wound around V13, V14, V15, and V16 in this order while alternately repeating clockwise (cw) and counterclockwise (ccw) to form each coil and reaches a winding end part 41B in the vicinity of V16. The winding start part 41A and the winding end part 41B of the wire are drawn out to one side in the axial direction of the stator 2.

The portion 42 included in the second stator 22 in the second coil group 4 is formed as follows. First, in the vicinity of V21, the winding is started from a winding start part 42A, and the wire is wound around V21 clockwise (cw) to form a coil. Next, the connecting wire 420 is formed on the other side (the side opposite to the first stator 21) of the second stator 22 in the axial direction, and the wire is wound around V22 counterclockwise (ccw) to form a coil. Thereafter, similarly, the wire is wound around V23, V24, V25, and V26 in this order while alternately repeating clockwise (cw) and counterclockwise (ccw) to form each coil and reaches the winding end part 42B in the vicinity of V26. The winding start part 42A and the winding end part 42B of the wire are drawn out to one side in the axial direction of the stator 2.

In the second coil group 4, the winding end part 41B of the portion 41 included in the first stator 21 is connected to the winding end part 42B of the portion 42 included in the second stator 22. That is, in the second coil group 4, an end part 41e on the winding end side of the portion 41 included in the first stator 21 is electrically connected to an end part 42e on the winding end side of the portion 42 included in the second stator 22. Thus, the portion 41 of the second coil group 4 included in the first stator 21 is electrically connected in series to the portion 42 included in the second stator 22. Therefore, in the second coil group 4, a direction of a current flow to the portion 41 included in the first stator 21 is opposite to a direction of a current flow to the portion 42 included in the second stator 22 in the circumferential direction.

The third coil group 5 includes a portion 51 included in the first stator 21 and a portion 52 included in the second stator 22. The portion 51 of the third coil group 5 included in the first stator 21 is formed by winding one wire in the order of W11, W12, W13, W14, W15, and W16 and is composed of a plurality of coils electrically connected in series and a connecting wire 510 connecting the coils. The portion 52 of the third coil group 5 included in the second stator 22 is formed by winding one wire in the order of W21, W22, W23, W24, W25, and W26 and is composed of a plurality of coils electrically connected in series and a connecting wire 520 connecting the coils.

The portion 51 of the third coil group 5 included in the first stator 21 is formed as follows. First, in the vicinity of W11, the winding is started from a winding start part 51A, and the wire is wound around W11 clockwise (cw) to form a coil. Next, the connecting wire 510 is formed on one side (the side opposite to the second stator 22) of the first stator 21 in the axial direction, and the wire is wound around W12 counterclockwise (ccw) to form a coil. Thereafter, similarly, the wire is wound around W13, W14, W15, and W16 in this order while alternately repeating clockwise (cw) and counterclockwise (ccw) to form each coil and reaches a winding end part 51B in the vicinity of W16. The winding start part 51A and the winding end part 51B of the wire are drawn out to one side in the axial direction of the stator 2.

The portion 52 of the third coil group 5 included in the second stator 22 is formed as follows. First, in the vicinity of W21, the winding is started from a winding start part 52A, and the wire is wound around W21 clockwise (cw) to form a coil. Next, the connecting wire 520 is formed on the other side (the side opposite to the first stator 21) of the second stator 22 in the axial direction, and the wire is wound around W22 counterclockwise (ccw) to form a coil. Thereafter, similarly, the wire is wound around W23, W24, W25, and W26 in this order while alternately repeating clockwise (cw) and counterclockwise (ccw) to form each coil and reaches a winding end part 52B in the vicinity of W26. The winding start part 52A and the winding end part 52B of the wire are drawn out to one side in the axial direction of the stator 2.

In the third coil group 5, the winding end part 51B of the portion 51 included in the first stator 21 is connected to the winding end part 52B of the portion 52 included in the second stator 22. That is, in the third coil group 5, an end part 51e on the winding end side of the portion 51 included in the first stator 21 is electrically connected to an end part 52e on the winding end side of the portion 52 included in the second stator 22. Thus, the portion 51 included in the first stator 21 of the third coil group 5 is electrically connected in series to the portion 52 included in the second stator 22. Therefore, in the third coil group 5, a direction of a current flow to the portion 51 included in the first stator 21 is opposite to a direction of a current flow to the portion 52 included in the second stator 22 in the circumferential direction.

After the first coil group 3 to the third coil group 5 are formed as described above, the first stator 21 and the second stator 22 are assembled to form the integrated stator 2, thereby completing the winding operation.

When each coil in the first coil group 3 to the third coil group 5 is formed as described above, the coil is formed by spirally winding a wire around each tooth from the other side (the inner side, the direction of arrow d) to the one side (the outer side, the direction of arrow c) in the radial direction or from the one side to the other side. Any number of windings of a coil is used.

Depending on the number of turns, for example, a first layer coil may be formed from the other side (the inner side, the direction of arrow d) to the one side (the outer side, the direction of arrow c) in the radial direction, and then a second layer coil may be formed from the one side (the outer side, the direction of arrow c) to the other side (the inner side, the direction of arrow d) in the radial direction. Any number of layers is used. When the coil is formed in a plurality of layers, a layer on a side close to the tooth (inner layer) is a winding start side, a layer on a side away from the tooth (outer layer) is a winding end side, and it can thus be determined that in two coils connected by a connecting wire, a coil with the connecting wire connected to the outer layer is a coil on the winding start side and that a coil with the connecting wire connected to the inner layer is a coil on the winding end side.

When a certain coil is formed by winding the wire from the other side (the inner side, the direction of arrow d) to the one side (the outer side, the direction of arrow c) in the radial direction, the next coil to be formed may be formed by winding the wire from the one side (the outer side, the direction of arrow c) to the other side (the inner side, the direction of arrow d) in the radial direction. In this case, the plurality of connecting wires formed sequentially in the circumferential direction may be alternately arranged on the other side (inner side, arrow d direction) and one side (outer side, arrow c direction) in the radial direction or may be arranged such that the winding start side is always on either the other side (inner side, arrow d direction) or the one side (outer side, arrow c direction) in the radial direction.

By forming the first coil group 3 to the third coil group 5 as described above, in the first stator 21, the coils constituting the first coil group 3, the coils constituting the second coil group 4, and the coils constituting the third coil group 5 are arranged in this order in the first direction A in the circumferential direction. Similarly, in the second stator 22, the coils constituting the first coil group 3, the coils constituting the second coil group 4, and the coils constituting the third coil group 5 are arranged in this order in the first direction A in the circumferential direction.

In the stator 2 with the first stator 21 and the second stator 22 assembled, the coil constituting the portion 31 included in the first stator 21 and the coil constituting the portion 32 included in the second stator 22 in the first coil group 3 are adjacent to each other in the circumferential direction. Similarly, in the second coil group 4, the coil constituting the portion 41 included in the first stator 21 and the coil constituting the portion 42 included in the second stator 22 are adjacent to each other in the circumferential direction. In the third coil group 5, the coil constituting the portion 51 included in the first stator 21 and the coil constituting the portion 52 included in the second stator 22 are adjacent to each other in the circumferential direction.

The first coil group 3 to the third coil group 5 are connected as described below. An end part 32s of the winding start side of the portion 32 included in the second stator 22 in the first coil group 3 is connected to an end part 41s of the winding start side of the portion 41 of the second coil group 4 included in the first stator 21, and serves as the contact 13 of the delta connection (see FIG. 2). An end part 42s of the winding start side of the portion 42 included in the second stator 22 in the second coil group 4 is connected to an end part 51s of the winding start side of the portion 51 included in the first stator 21 in the third coil group 5, and serves as the contact 14 of the delta connection. An end part 52s of the winding start side of the portion 52 included in the second stator 22 in the third coil group 5 is connected to an end part 31s of the winding start side of the portion 31 included in the first stator 21 in the first coil group 3, and serves as the contact 15 of the delta connection.

The motor 1 according to the present embodiment can be assembled after the windings are applied to the first stator 21 and the second stator 22. Each of the first stator 21 and the second stator 22 includes half the number of teeth as compared with the stator 2 after assembly. Even when the number of teeth is large in the entire stator 2, a space corresponding to one tooth is generated between adjacent teeth in the first stator 21 and the second stator 22 before assembly, causing easy winding operation on each of the first stator 21 and the second stator 22. After the windings are applied around the first stator 21 and the second stator 22, the first stator 21 and the second stator 22 are assembled to form the integrated stator, thereby completing the winding operation of the stator 2 as a whole. Therefore, windings are easily applied to the motor 1 according to the present embodiment.

For the same reason, the motor 1 according to the present embodiment does not need to increase the distance (slot opening) between the tips of the adjacent teeth in the stator 2.

Therefore, the slot opening can be made closer to the ideal value, and the motor characteristics can be easily improved.

In the motor 1 according to the present embodiment, in each of the first coil group 3, the second coil group 4, and the third coil group 5, the portion included in the first stator 21 is electrically connected in series to the portion included in the second stator 22. Therefore, in each of the first coil group 3, the second coil group 4, and the third coil group 5, a phase difference is less likely to occur between a voltage generated by a portion included in the first stator 21 and a voltage generated by a portion included in the second stator 22, and it is possible to suppress the occurrence of an unintended reflux current, the deterioration of motor characteristics due to the reflux current, the occurrence of abnormal torque, and the like.

### Second Embodiment

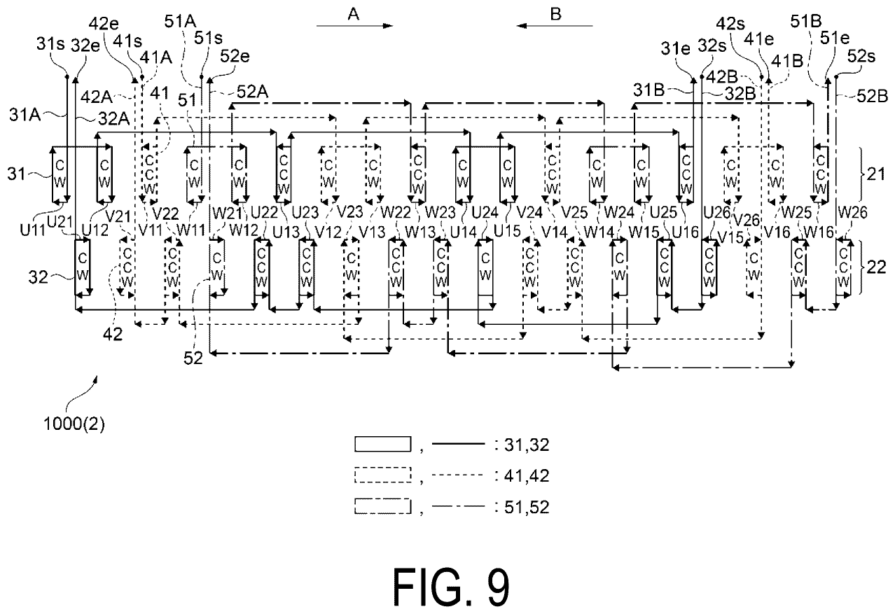

Next, a second embodiment as one example of the present invention will be described with reference to the drawings. FIG. 9 is a schematic diagram of each coil group of the motor 1000 according to the present embodiment. The motor 1000 according to the present embodiment has the same or substantially the same configuration as the motor 1 according to the first embodiment except that the method of winding the coil groups around the first stator 21 and the second stator 22 is different. Members and components having the same functions and configurations as the members and components of the first embodiment are given the same reference signs of the first embodiment, and detailed descriptions of the members and components will be omitted below.

Hereinafter, for the sake of simplicity, of the plurality of teeth 212 of the first stator 21, the first tooth is defined as U11, the second tooth as U12, the sixth tooth as U13, the tenth tooth as U14, the eleventh tooth as U15, and the fifteenth tooth as U16. The third tooth of the first stator 21 is defined as V11, the seventh tooth as V12, the eighth tooth as V13, the twelfth tooth as V14, the sixteenth tooth as V15, and the seventeenth tooth as V16. The fourth tooth of the first stator 21 is defined as W11, the fifth tooth as W12, the ninth tooth as W13, the thirteenth tooth as W14, the fourteenth tooth as W15, and the eighteenth tooth as W16. That is, from the first tooth of the first stator 21 toward the first direction A, these teeth are defined as U11, U12, V11, W11, W12, U13, V12, V13, W13, U14, U15, V14, W14, W15, U16, V15, V16, and W16. In the first stator 21, the tooth adjacent to W16 in the first direction A is U11.

Similarly, of the plurality of teeth 222 of the second stator 22, the first tooth is defined as U21, the fifth tooth as U22, the sixth tooth as U23, the tenth tooth as U24, the fourteenth tooth as U25, and the fifteenth tooth as U26. The second tooth of the second stator 22 is defined as V21, the third tooth as V22, the seventh tooth as V23, the eleventh tooth as V24, the twelfth tooth as V25, and the sixteenth tooth as V26. The fourth tooth of the second stator 22 is defined as W21, the eighth tooth as W22, the ninth tooth as W23, the thirteenth tooth as W24, the seventeenth tooth as W25, and the eighteenth tooth as W26. That is, from the first tooth of the second stator 22 toward the first direction A, these teeth are defined as U21, V21, V22, W21, U22, U23, V23, W22, W23, U24, V24, V25, W24, U25, U26, V26, W25, and W26. In the second stator 22, the tooth adjacent to W26 in the first direction A is U21.

The first coil group 3 forming the first phase (U phase) is wound around U11, U12, U13, U14, U15, and U16 of the plurality of teeth 212 of the first stator 21, and around U21, U22, U23, U24, U25, and U26 of the plurality of teeth 222 of the second stator 22. The second coil group 4 forming the second phase (V phase) is wound around V11, V12, V13, V14, V15, and V16 of the plurality of teeth 212 of the first stator 21, and V21, V22, V23, V24, V25, and V26 of the multiple teeth 222 of the second stator 22. The third coil group 5 forming the third phase (W phase) is wound around W11, W12, W13, W14, W15, and W16 of the plurality of teeth 212 of the first stator 21, and around W21, W22, W23, W24, W25, and W26 of the plurality of teeth 222 of the second stator 22.

Therefore, as illustrated in FIG. 9, in the plurality of teeth 212 of the first stator 21, the number of teeth wound around with a wire belonging to the same coil group is one-third of the total number of the plurality of teeth 212. Among them, two teeth wound around with the wire belonging to the same coil group and continuous (adjacent) in the circumferential direction (for example, U11 and U12, hereinafter also referred to as “continuous teeth”) and teeth not adjacent to the teeth wound around with the wire belonging to the same coil group (for example, U13, hereinafter also referred to as “single teeth”) are alternately arranged sandwiching three teeth wound around with a wire belonging to another coil group and continuous in the circumferential direction (for example, V11, W11, and W12). In the plurality of teeth 222 of the second stator 22, the number of teeth wound around with a wire belonging to the same coil group is one-third of the total number of the plurality of teeth 222, and among them, the continuous teeth and the single teeth are alternately arranged sandwiching three circumferentially continuous teeth wound around with a wire belonging to another coil group.

In other words, in the first coil group 3, the portion included in the first stator 21 includes a portion wound around one tooth but not wound around any tooth adjacent to the tooth in the circumferential direction (hereinafter, also referred to as a discontinuous portion) and a portion (hereinafter, also referred to as a continuous portion) continuously wound around two teeth adjacent to each other in the circumferential direction, with the portions being alternately arranged in the circumferential direction, and three adjacent teeth wound around with a wire belonging to another coil group are sandwiched between the discontinuous portion and the continuous portion. The same applies to the second coil group 4 and the third coil group 5. A portion of the first coil group 3 included in the second stator 22 also includes a discontinuous portion and a continuous portion alternately in the circumferential direction. Three adjacent teeth wound around another coil group are sandwiched between the discontinuous portion and the continuous portion. The same applies to the second coil group 4 and the third coil group 5.

In the first stator 21, the winding directions of the wires in the two teeth constituting the continuous teeth are the same, and the winding directions are opposite to the winding directions of the wires in the single teeth. In the second stator 22, the winding directions of the wires in the two teeth constituting the continuous teeth are the same, and the winding directions are opposite to the winding directions of the wires in the single teeth. Further, the winding direction of the wire in the continuous teeth of the first stator 21 is opposite to the winding direction of the wire in the continuous teeth of the second stator 22 and is the same as the winding direction of the wire in the single teeth of the second stator 22. However, as necessary, the winding direction of the wire in the continuous teeth of the first stator 21 may be the same as the winding direction of the wire in the continuous teeth of the second stator 22, and may be opposite to the winding direction of the wire in the single teeth of the second stator 22.

Further, in the stator 2 with the first stator 21 and the second stator 22 are assembled, the single teeth of the second stator wound around with the wire belonging to the same coil group are sandwiched between the continuous teeth of the first stator 21 in the circumferential direction. Similarly, in the circumferential direction, the single teeth of the first stator wound around with the wire belonging to the same coil group are sandwiched between the continuous teeth of the second stator 22. Therefore, in the stator 2, the teeth wound around with the wire belonging to the same coil group form a plurality of tooth groups each including three teeth continuous (adjacent) in the circumferential direction, and six teeth continuous in the circumferential direction and wound around with the wire belonging to another coil group are sandwiched between a certain tooth group and another tooth group adjacent to the certain tooth group in the circumferential direction.

The windings are applied to the first stator 21 and the second stator 22 with the first stator 21 and the second stator 22 unassembled (separated). Hereinafter, a method of winding the first stator 21 and the second stator 22 will be described in detail. FIG. 9 is a schematic view of the first stator 21 and the second stator 22 developed on a plane when viewed from the other side in the radial direction (the inner side, the direction of arrow d). In FIG. 9, arrows indicate winding directions of a wire and are unrelated to a direction of a current flow. In FIG. 9, some of the wires are omitted.

In the first coil group 3, the portion 31 included in the first stator 21 is formed as follows. First, in the vicinity of U11, the winding is started from a winding start part 31A, and the wire is wound around U11 clockwise (cw) to form a coil. Next, a wire is wound clockwise (cw) around the adjacent U12 to form a coil. Next, a connecting wire is formed on one side (the side opposite to the second stator 22) of the first stator 21 in the axial direction, and the wire is wound around U13 counterclockwise (ccw) to form a coil. Next, the connecting wire is formed again on one side in the axial direction, and the wire is wound clockwise (cw) around U14 to form a coil. Next, a wire is wound clockwise (cw) around the adjacent U15 to form a coil. Then, while forming a connecting wire on one side of the first stator 21 in the axial direction, the wire is wound around U16 counterclockwise (ccw) to form a coil and reaches the winding end part 31B in the vicinity of U16. The winding start part 31A and the winding end part 31B of the wire are drawn out to one side in the axial direction of the stator 2.

In the first coil group 3, the portion 32 included in the second stator 22 is formed as follows. First, in the vicinity of U26, the winding is started from the winding start part 32B, and the wire is wound around U26 counterclockwise (ccw) to form a coil. Next, a wire is wound around the adjacent U25 counterclockwise (ccw) to form a coil. Next, a connecting wire is formed on the other side (the side opposite to the first stator 21) of the second stator 22 in the axial direction, and the wire is wound around U24 clockwise (cw) to form a coil. Next, the connecting wire is formed again on the other side in the axial direction, and the wire is wound around U23 counterclockwise (ccw) to form the coil. Next, a wire is wound around the adjacent U22 counterclockwise (ccw) to form a coil. Then, while forming a connecting wire on the other side of the second stator 22 in the axial direction, the wire is wound clockwise (cw) around U21 to form a coil and reaches the winding end part 32A in the vicinity of U21. The winding start part 32B and the winding end part 32A of the wire are drawn out to one side in the axial direction of the stator 2.

In the first coil group 3, a winding end part 31B of the portion 31 included in the first stator 21 is connected to a winding start part 32B of the portion 32 included in the second stator 22. That is, in the first coil group 3, the end part 31e on the winding end side of the portion 31 included in the first stator 21 is electrically connected to the end part 32s on the winding start side of the portion 32 included in the second stator 22. Thus, in the first coil group 3, the portion 31 included in the first stator 21 is electrically connected in series to the portion 32 included in the second stator 22. Therefore, in the first coil group 3, a direction of a current flow to the portion 31 included in the first stator 21 is opposite to a direction of a current flow to the portion 32 included in the second stator 22 in the circumferential direction.

As illustrated in FIG. 9, the second coil group 4 and the third coil group 5 are formed according to the method of forming the first coil group 3 described above. In the present embodiment, the first coil group 3, the second coil group 4, and the third coil group 5 are formed by winding the wire around the plurality of teeth 212 sequentially toward the first direction A of the circumferential direction and winding the wire around the plurality of teeth 222 sequentially toward the second direction B of the circumferential direction. That is, in the present embodiment, the direction of winding the wire to form the plurality of coils in the first stator 21 is opposite to the direction of winding the wire to form the coils in the second stator 22.

The portion 41 of the second coil group 4 included in the first stator 21 is formed as follows. First, in the vicinity of V11, the winding is started from the winding start part 41A, and the wire is wound around V11 counterclockwise (ccw) to form a coil. Next, a connecting wire is formed on one side of the first stator 21 in the axial direction, and a wire is wound around V12 clockwise (cw) to form a coil. Next, a wire is wound clockwise (cw) around the adjacent V13 to form a coil. Next, a connecting wire is formed on one side of the first stator 21 in the axial direction, and the wire is wound around V14 counterclockwise (ccw) to form a coil. Next, the connecting wire is formed again on one side in the axial direction, and the wire is wound clockwise (cw) around V15 to form a coil. Next, the wire is wound clockwise (cw) around the adjacent V16 to form a coil and reaches the winding end part 41B in the vicinity of V16. The winding start part 41A and the winding end part 41B of the wire are drawn out to one side in the axial direction of the stator 2.

The portion 42 included in the second stator 22 in the second coil group 4 is formed as follows. First, in the vicinity of V26, the winding is started from the winding start part 42B, and the wire is wound around V26 clockwise (cw) to form a coil. Next, a connecting wire is formed on the other side of the second stator 22 in the axial direction, and the wire is wound around V25 counterclockwise (ccw) to form a coil. Next, a wire is wound around the adjacent V24 counterclockwise (ccw) to form a coil. Next, a connecting wire is formed on the other side of the second stator 22 in the axial direction, and the wire is wound around V23 clockwise (cw) to form a coil. Next, the connecting wire is formed again on the other side in the axial direction, and the wire is wound around V22 counterclockwise (ccw) to form the coil. Then, the wire is wound around the adjacent V21 counterclockwise (ccw) to form a coil and reaches the winding end part 42A in the vicinity of V21. The winding start part 42B and the winding end part 42A of the wire are drawn out to one side in the axial direction of the stator 2.

In the second coil group 4, a winding end part 41B of the portion 41 included in the first stator 21 is connected to a winding start part 42B of the portion 42 included in the second stator 22. That is, in the second coil group 4, the end part 41e on the winding end side of the portion 41 included in the first stator 21 is electrically connected to the end part 42s on the winding start side of the portion 42 included in the second stator 22. Thus, the portion 41 of the second coil group 4 included in the first stator 21 is electrically connected in series to the portion 42 included in the second stator 22. Therefore, in the second coil group 4, a direction of a current flow to the portion 41 included in the first stator 21 is opposite to a direction of a current flow to the portion 42 included in the second stator 22 in the circumferential direction.

The portion 51 of the third coil group 5 included in the first stator 21 is formed as follows. First, in the vicinity of W11, the winding is started from a winding start part 51A, and the wire is wound around W11 clockwise (cw) to form a coil. Next, a wire is wound clockwise (cw) around the adjacent W12 to form a coil. Next, a connecting wire is formed on one side of the first stator 21 in the axial direction, and the wire is wound around W13 counterclockwise (ccw) to form a coil. Next, the connecting wire is formed again on one side in the axial direction, and the wire is wound clockwise (cw) around W14 to form a coil. Next, a wire is wound clockwise (cw) around the adjacent W15 to form a coil. Then, while forming a connecting wire on one side of the first stator 21 in the axial direction, the wire is wound around W16 counterclockwise (ccw) to form a coil and reaches the winding end part 51B in the vicinity of W16. The winding start part 51A and the winding end part 51B of the wire are drawn out to one side in the axial direction of the stator 2.

The portion 52 of the third coil group 5 included in the second stator 22 is formed as follows. First, in the vicinity of W26, the winding is started from the winding start part 52B, and the wire is wound around W26 counterclockwise (ccw) to form a coil. Next, a wire is wound around the adjacent W25 counterclockwise (ccw) to form a coil. Next, a connecting wire is formed on the other side of the second stator 22 in the axial direction, and the wire is wound around W24 clockwise (cw) to form a coil. Next, the connecting wire is formed again on the other side in the axial direction, and the wire is wound around W23 counterclockwise (ccw) to form the coil. Next, a wire is wound around the adjacent W22 counterclockwise (ccw) to form a coil. Then, while forming a connecting wire on the other side of the second stator 22 in the axial direction, the wire is wound clockwise (cw) around W21 to form a coil and reaches the winding end part 52A in the vicinity of W21. The winding start part 52B and the winding end part 52A of the wire are drawn out to one side in the axial direction of the stator 2.

In the third coil group 5, a winding end part 51B of the portion 51 included in the first stator 21 is connected to a winding start part 52B of the portion 52 included in the second stator 22. That is, in the third coil group 5, the end part 51e on the winding end side of the portion 51 included in the first stator 21 is electrically connected to the end part 52s on the winding start side of the portion 52 included in the second stator 22. Thus, the portion 51 included in the first stator 21 of the third coil group 5 is electrically connected in series to the portion 52 included in the second stator 22. Therefore, in the third coil group 5, a direction of a current flow to the portion 51 included in the first stator 21 is opposite to a direction of a current flow to the portion 52 included in the second stator 22 in the circumferential direction.

After the first coil group 3 to the third coil group 5 are formed as described above, the first stator 21 and the second stator 22 are assembled to form the integrated stator 2, thereby completing the winding operation.

By forming the first coil group 3 to the third coil group 5 as described above, in the first stator 21, two coils constituting the first coil group 3, one coil constituting the second coil group 4, two coils constituting the third coil group 5, one coil constituting the first coil group 3, two coils constituting the second coil group 4, and one coil constituting the third coil group 5 are arranged in this order in the first direction A in the circumferential direction. In the second stator 22, one coil constituting the first coil group 3, two coils constituting the second coil group 4, one coil constituting the third coil group 5, two coils constituting the first coil group 3, one coil constituting the second coil group 4, and two coils constituting the third coil group 5 are arranged in this order in the first direction A in the circumferential direction.

The first coil group 3 to the third coil group 5 are connected as described below. The end part 32e of the portion 32 included in the second stator 22 of the first coil group 3 on the winding end side is connected to the end part 41s of the portion 41 included in the first stator 21 of the second coil group 4 on the winding start side, and serves as the contact 13 of the delta connection (see FIG. 2). The end part 42e of the winding end side of the portion 42 included in the second stator 22 in the second coil group 4 is connected to the end part 51s of the winding start side of the portion 51 included in the first stator 21 in the third coil group 5, and serves as a contact 14 of the delta connection. The end part 52e of the winding-end side of the portion 52 included in the second stator 22 in the third coil group 5 is connected to the end part 31s of the winding-start side of the portion 31 included in the first stator 21 in the first coil group 3, and serves as the contact 15 of the delta connection.

For the same reason as the motor 1 according to the first embodiment, the motor 1000 according to the present embodiment has a winding to be easily applied, easily improves motor characteristics, and can suppress the occurrence of an unintended reflux current, deterioration of motor characteristics due to the reflux current, the occurrence of abnormal torque, and the like.

In the motor 1000 according to the present embodiment, the number of magnetic poles of the permanent magnets in the rotor 6 is not limited, but the winding method in the motor 1000 according to the present embodiment can be suitably combined with the rotor 6 having, for example, forty magnetic poles. However, the rotor 6 may have another number of magnetic poles.

### Third Embodiment

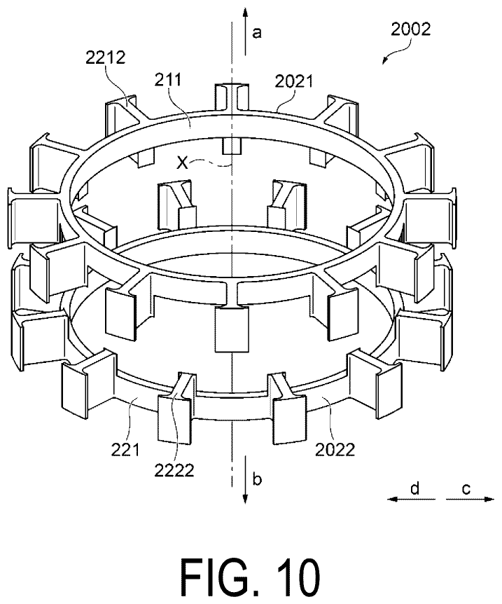

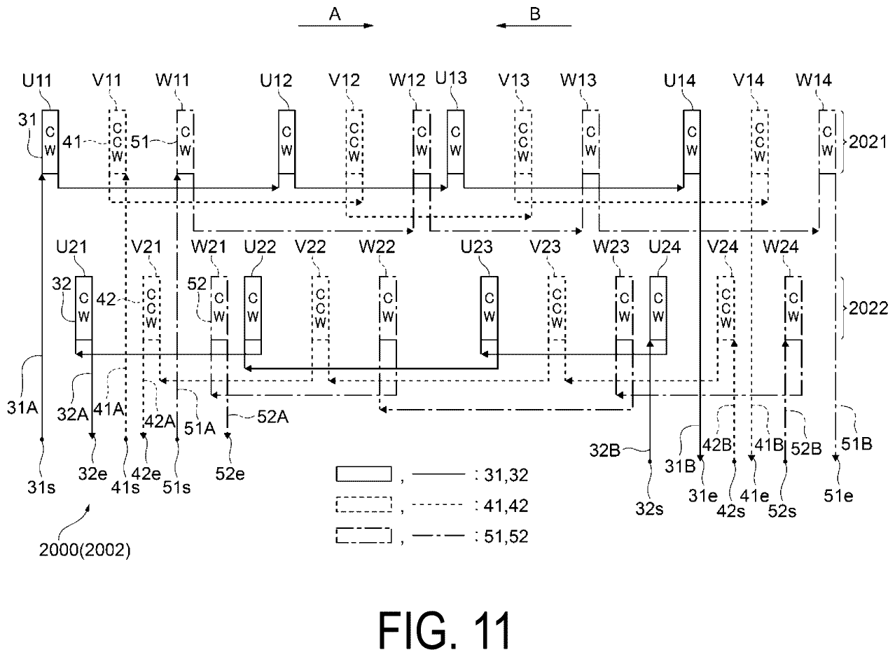

Next, a third embodiment as one example of the present invention will be described with reference to the drawings. FIG. 10 is an exploded perspective view of a stator 2002 of a motor 2000 according to the present embodiment, and FIG. 11 is a schematic view of the first coil group 3, the second coil group 4, and the third coil group 5 of the motor 2000. The motor 2000 according to the present embodiment has a similar configuration to the motor 1 according to the first embodiment except that the stator 2002 instead of the stator 2 is included and that the winding method of each coil group is different. Members and components having the same functions and configurations as the members and components of the first embodiment are given the same reference signs of the first embodiment, and detailed descriptions of the members and components will be omitted below.

As illustrated in FIG. 10, the stator 2002 includes a first stator 2021 and a second stator 2022 formed separately from each other. The first stator 2021 and the second stator 2022 may each be formed by stacking a magnetic material having a thin plate shape or may be formed by a single member having a lump shape.

The first stator 2021 and the second stator 2022 have the same configurations as the first stator 21 and the second stator 22 of the motor 1 according to the first embodiment, respectively, except that the number of teeth (magnetic pole parts) is different. The first stator 2021 includes a plurality of (twelve in the present embodiment) teeth (magnetic pole parts) 2212 having a T-shaped cross-sectional shape. The second stator 2022 includes a plurality of (twelve in the present embodiment) teeth (magnetic pole parts) 2222 having a T-shaped cross-sectional shape.

The first stator 2021 and the second stator 2022 are assembled such that the yoke 211 of the first stator 2021 and the yoke 221 of the second stator 2022 overlap in the axial direction and are thus integrated to form the stator 2002. The first stator 2021 and the second stator 2022 are assembled such that the teeth 2212 and the teeth 2222 are adjacent to each other (alternated) in the circumferential direction.

Of the plurality of teeth 2212 of first stator 2021, any tooth is defined as a first tooth, a tooth adjacent to the first tooth in first direction A in the circumferential direction is defined as a second tooth, and the number of the tooth increases toward first direction A. Similarly, of the plurality of teeth 2222 of second stator 2022, any tooth is defined as a first tooth, a tooth adjacent to the first tooth in first direction A in the circumferential direction is defined as a second tooth, and the number of the tooth increases toward first direction A. With the first stator 2021 and the second stator 2022 assembled, the first tooth of the second stator 2022 is adjacent to the first tooth of the first stator 2021 in the first direction A.

Hereinafter, of the plurality of teeth 2212 of the first stator 2021, the first tooth is defined as U11, the fourth tooth as U12, the seventh tooth as U13, and the tenth tooth as U14 for the sake of simplicity. The second tooth of the first stator 2021 is defined as V11, the fifth tooth as V12, the eighth tooth as V13, and the eleventh tooth as V14. The third tooth of the first stator 2021 is defined as W11, the sixth tooth as W12, the ninth tooth as W13, and the twelfth tooth as W14. That is, from the first tooth of the first stator 2021 toward the first direction A, these teeth are defined as U11, V11, W11, U12, V12, W12, U13, V13, W13, U14, V14, and W14. In the first stator 2021, the tooth adjacent to W14 in the first direction A is U11.

Similarly, of the plurality of teeth 2222 of the second stator 2022, the first tooth is defined as U21, the fourth tooth as U22, the seventh tooth as U23, and the tenth tooth as U24. The second tooth of the second stator 2022 is defined as V21, the fifth tooth as V22, the eighth tooth as V23, and the eleventh tooth as V24. The third tooth of the second stator 2022 is defined as W21, the sixth tooth as W22, the ninth tooth as W23, and the twelfth tooth as W24. That is, from the first tooth of the second stator 2022 toward the first direction A, these teeth are defined as U21, V21, W21, U22, V22, W22, U23, V23, W23, U24, V24, and W24. In second stator 2022, the tooth adjacent to W24 in first direction A is U21.

The first coil group 3 forming the first phase (U phase) is wound around U11, U12, U13, U14 in the plurality of teeth 2212 of the first stator 2021, and U21, U22, U23, U24 in the plurality of teeth 2222 of the second stator 2022. The second coil group 4 forming the second phase (V phase) is wound around V11, V12, V13, V14 in the plurality of teeth 2212 of the first stator 2021, and V21, V22, V23, V24 in the plurality of teeth 2222 of the second stator 2022. The third coil group 5 forming the third phase (W phase) is wound around W11, W12, W13, W14 in the plurality of teeth 2212 of the first stator 2021, and W21, W22, W23, W24 in the plurality of teeth 2222 of the second stator 2022. The windings are applied to the first stator 2021 and the second stator 2022 with the first stator 2021 and the second stator 2022 unassembled (separated). Hereinafter, a method of winding the first stator 2021 and the second stator 2022 will be described in detail.

The first coil group 3 includes the portion 31 included in the first stator 2021 and the portion 32 included in the second stator 2022. In the first coil group 3, the portion 31 included in the first stator 2021 is formed by winding one wire in the order of U11, U12, U13, U14 and is composed of a plurality of coils electrically connected in series and a connecting wire connecting the coils to each other. In the first coil group 3, the portion 32 included in the second stator 2022 is formed by winding one wire in the order of U24, U23, U22, U21 and is composed of a plurality of coils electrically connected in series and a connecting wire connecting the coils to each other.

FIG. 11 is a schematic view of the first stator 2021 and the second stator 2022 developed on a plane when viewed from the other side in the radial direction (the inner side, the direction of arrow d). In FIG. 11, for convenience of drawing, the distance between the teeth in the circumferential direction is illustrated to be varied, but actually, the distance between the teeth in the circumferential direction is constant. In FIG. 11, arrows indicate winding directions of a wire and are unrelated to a direction of a current flow. In FIG. 11, the wires are illustrated with some parts omitted.

The portion 31 included in the first stator 2021 in the first coil group 3 is formed as follows. First, in the vicinity of U11, the winding is started from a winding start part 31A, and the wire is wound around U11 clockwise (cw) to form a coil. Next, the wire is wound clockwise (cw) around U12 to form a coil while forming a connecting wire. Thereafter, similarly, the wire is wound clockwise around U13 and U14 sequentially to form each coil and reaches the winding end part 31B in the vicinity of U14.

The portion 32 of the first coil group 3 included in the second stator 2022 is formed as follows. First, in the vicinity of U24, the winding is started from the winding start part 32B, and the wire is wound around U24 clockwise (cw) to form a coil. Next, the wire is wound clockwise (cw) around U23 to form a coil while forming a connecting wire. Thereafter, similarly, the wire is wound clockwise around U22 and U21 sequentially to form each coil and reaches the winding end part 32A in the vicinity of U21.

In the first coil group 3, the winding end part 31B of the portion 31 included in the first stator 2021 is connected to the winding start part 32B of the portion 32 included in the second stator 2022. That is, in the first coil group 3, the end part 31e on the winding end side of the portion 31 included in the first stator 2021 is electrically connected to the end part 32s on the winding start side of the portion 32 included in the second stator 2022. Accordingly, the portion 31 included in the first stator 2021 of the first coil group 3 is electrically connected in series to the portion 32 included in the second stator 2022. Therefore, in the first coil group 3, a direction of a current flow to the portion 31 included in the first stator 2021 is opposite to a direction of a current flow to the portion 32 included in the second stator 2022 in the circumferential direction.

As illustrated in FIG. 11, the second coil group 4 and the third coil group 5 are formed according to the method of forming the first coil group 3 described above. In the present embodiment, the first coil group 3, the second coil group 4, and the third coil group 5 are formed by winding the wire around the plurality of teeth 2212 sequentially toward the first direction A of the circumferential direction and winding the wire around the plurality of teeth 2222 sequentially toward the second direction B of the circumferential direction. That is, in the present embodiment, the direction of winding the wire to form the plurality of coils in the first stator 2021 is opposite to the direction of winding the wire to form the coils in the second stator 2022.

The second coil group 4 includes a portion 41 included in the first stator 2021 and a portion 42 included in the second stator 2022. In the second coil group 4, the portion 41 included in the first stator 2021 is formed by winding one wire in the order of V11, V12, V13, and V14 and is composed of a plurality of coils electrically connected in series and a connecting wire connecting the coils. In the second coil group 4, a portion 42 included in the second stator 2022 is formed by winding one wire in the order of V24, V23, V22, and V21 and is composed of a plurality of coils electrically connected in series and a connecting wire connecting the coils.

The portion 41 of the second coil group 4 included in the first stator 2021 is formed as follows. First, in the vicinity of V11, the winding is started from the winding start part 41A, and the wire is wound around V11 counterclockwise (ccw) to form a coil. Next, the wire is wound around V12 counterclockwise (ccw) to form a coil while forming a connecting wire. Thereafter, similarly, the wire is wound counterclockwise around V13 and V14 sequentially to form each coil and reaches the winding end part 41B in the vicinity of V14.

The portion 42 included in the second stator 2022 in the second coil group 4 is formed as follows. First, in the vicinity of V24, the winding is started from the winding start part 42B, and the wire is wound around V24 counterclockwise (ccw) to form a coil. Next, the wire is wound around V23 counterclockwise (ccw) to form a coil while forming a connecting wire. Thereafter, similarly, the wire is wound counterclockwise around V22 and V21 sequentially to form each coil and reaches the winding end part 42A in the vicinity of V21.

In the second coil group 4, the winding end part 41B of the portion 41 included in the first stator 2021 is connected to the winding start part 42B of the portion 42 included in the second stator 2022. That is, in the second coil group 4, the end part 41e on the winding end side of the portion 41 included in the first stator 2021 is electrically connected to the end part 42s on the winding start side of the portion 42 included in the second stator 2022. Thus, the portion 41 included in the first stator 2021 of the second coil group 4 is electrically connected in series to the portion 42 included in the second stator 2022. Therefore, in the second coil group 4, a direction of a current flow to the portion 41 included in the first stator 2021 is opposite to a direction of a current flow to the portion 42 included in the second stator 2022 in the circumferential direction.

The third coil group 5 includes a portion 51 included in the first stator 2021 and a portion 52 included in the second stator 2022. In the third coil group 5, a portion 51 included in the first stator 2021 is formed by winding one wire in the order of W11, W12, W13, and W14 and is composed of a plurality of coils electrically connected in series and a connecting wire connecting the coils. The portion 52 of the third coil group 5 included in the second stator 2022 is formed by winding one wire in the order of W24, W23, W22, and W21 and is composed of a plurality of coils electrically connected in series and a connecting wire connecting the coils.

The portion 51 of the third coil group 5 included in the first stator 2021 is formed as follows. First, in the vicinity of W11, the winding is started from a winding start part 51A, and the wire is wound around W11 clockwise (cw) to form a coil. Next, the wire is wound clockwise (cw) around W12 to form a coil while forming a connecting wire. Thereafter, similarly, the wire is wound clockwise around W13 and W14 sequentially to form each coil and reaches the winding end part 51B in the vicinity of W14.

The portion 52 of the third coil group 5 included in the second stator 2022 is formed as follows. First, in the vicinity of W24, the winding is started from the winding start part 52B, and the wire is wound around W24 clockwise (cw) to form a coil. Next, the wire is wound clockwise (cw) around W23 to form a coil while forming a connecting wire. Thereafter, similarly, the wire is wound clockwise around W22 and W21 sequentially to form each coil and reaches the winding end part 52A in the vicinity of W21.

In the third coil group 5, the winding end part 51B of the portion 51 included in the first stator 2021 is connected to the winding start part 52B of the portion 52 included in the second stator 2022. That is, in the third coil group 5, the end part 51e on the winding end side of the portion 51 included in the first stator 2021 is electrically connected to the end part 52s on the winding start side of the portion 52 included in the second stator 2022. Accordingly, the portion 51 included in the first stator 2021 in the third coil group 5 is electrically connected in series to the portion 52 included in the second stator 2022. Therefore, in the third coil group 5, a direction of a current flow to the portion 51 included in the first stator 2021 is opposite to a direction of a current flow to the portion 52 included in the second stator 2022 in the circumferential direction.

After the first coil group 3 to the third coil group 5 are formed as described above, the first stator 2021 and the second stator 2022 are assembled to form the integrated stator 2002, thereby completing the winding operation.

By forming the first coil group 3 to the third coil group 5 as described above, in the first stator 2021, the coils constituting the first coil group 3, the coils constituting the second coil group 4, and the coils constituting the third coil group 5 are arranged in this order in the first direction A in the circumferential direction. Similarly, in the second stator 2022, the coils constituting the first coil group 3, the coils constituting the second coil group 4, and the coils constituting the third coil group 5 are arranged in this order in the first direction A in the circumferential direction.

In the stator 2002 with the first stator 2021 and the second stator 2022 assembled, the coil constituting the portion 31 included in the first stator 2021 and the coil constituting the portion 32 included in the second stator 2022 in the first coil group 3 are adjacent to each other in the circumferential direction. Similarly, in the second coil group 4, the coil constituting the portion 41 included in the first stator 2021 and the coil constituting the portion 42 included in the second stator 2022 are adjacent to each other in the circumferential direction. In the third coil group 5, the coils constituting the portion 51 included in the first stator 2021 and the coils constituting the portion 52 included in the second stator 2022 are adjacent to each other in the circumferential direction.

The first coil group 3 to the third coil group 5 are connected as described below. The end part 32e of the portion 32 included in the second stator 2022 of the first coil group 3 on the winding end side is connected to the end part 41s of the portion 41 included in the first stator 2021 of the second coil group 4 on the winding start side, and serves as the contact 13 of the delta connection (see FIG. 2). The end part 42e of the winding end side of the portion 42 included in the second stator 2022 in the second coil group 4 is connected to the end part 51s of the winding start side of the portion 51 included in the first stator 2021 in the third coil group 5, and serves as a contact 14 of the delta connection. The end part 52e of the winding-end side of the portion 52 included in the second stator 2022 in the third coil group 5 is connected to the end part 31s of the winding-start side of the portion 31 included in the first stator 2021 in the first coil group 3, and serves as a contact 15 of the delta connection.

For the same reason as the motor 1 according to the first embodiment, the motor 2000 according to the present embodiment has a winding to be easily applied, easily improves motor characteristics, and can suppress the occurrence of an unintended reflux current, deterioration of motor characteristics due to the reflux current, the occurrence of abnormal torque, and the like.

In the motor 2000 according to the present embodiment, the number of magnetic poles of the permanent magnets in the rotor 6 is not limited, but the winding method in the motor 2000 according to the present embodiment can be suitably combined with the rotor 6 having, for example, twenty-eight magnetic poles. However, the rotor 6 may have another number of magnetic poles.

### Other Embodiments

In the first to third embodiments described above, the portion included in the first stator in each coil group is electrically connected in series to the portion included in the second stator. On the other hand, even when the portion included in the first stator is electrically connected in parallel to the portion included in the second stator in each coil group, a motor with winding to be easily applied can be provided. Hereinafter, examples of such motors will be described as modified examples of the first to third embodiments.

### First Modification

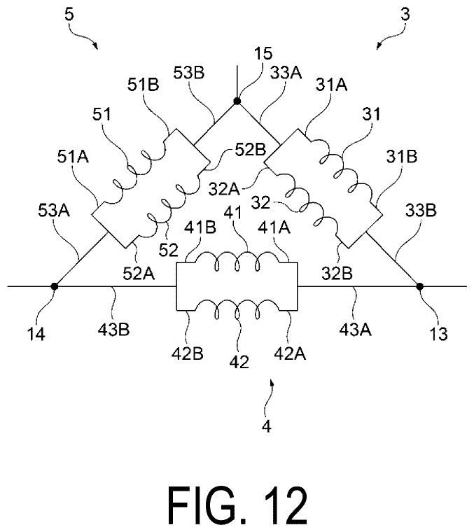

Hereinafter, a case (first modification) of electrically connecting the portion included in the first stator in parallel to the portion included in the second stator in each coil group in the first embodiment will be described. The motor according to the first modification has the same configuration as the motor 1 according to the first embodiment except that the method of connecting the wires is different, and thus the motor according to the first modification is also referred to as the motor 1 using the same reference numerals. Members and components having the same functions and configurations as the members and components of the first embodiment are given the same reference signs of the first embodiment, and detailed descriptions of the members and components will be omitted below. For the drawings, refer to mainly FIGS. 8 and 12.

In the first modification, the winding method of the first coil group 3, the second coil group 4, and the third coil group 5 is the same as that of the motor 1 according to the first embodiment. As illustrated in FIG. 12, the first coil group 3 forming a first phase (U phase), the second coil group 4 forming a second layer (V phase), and the third coil group 5 forming a third phase (W phase) form the delta connection.

Specifically, the first coil group 3 and the second coil group 4 are connected to each other at the contact 13, the second coil group 4 and the third coil group 5 are connected to each other at the contact 14, and the third coil group 5 and the first coil group 3 are connected to each other at the contact 15. A control device (not illustrated) is electrically connected to contacts 13, 14, and 15 of the delta connection. A DC power supply is electrically connected to two of the contacts 13, 14, and 15, and the connection is sequentially switched to periodically excite each coil group, thereby rotating the rotor 6 including the permanent magnets.

In the first coil group 3, the winding start part 31A of the portion 31 included in the first stator 21 is connected to the winding start part 32A of the portion 32 included in the second stator 22, and becomes one end part 33A of the first coil group 3 illustrated in FIG. 12. In the first coil group 3, the winding end part 31B of the portion 31 included in the first stator 21 is connected to the winding end part 32B of the portion 32 included in the second stator 22, and becomes the other end part 33B of the first coil group 3 illustrated in FIG. 12. Accordingly, in the first coil group 3, the portion 31 included in the first stator 21 is electrically connected in parallel to the portion 32 included in the second stator 22. Therefore, in the first coil group 3, a direction of a current flow to the portion 31 included in the first stator 21 is the same as a direction of a current flow to the portion 32 included in the second stator 22 in the circumferential direction.

In the second coil group 4, the winding start part 41A of the portion 41 included in the first stator 21 is connected to the winding start part 42A of the portion 42 included in the second stator 22, and becomes one end part 43A of the second coil group 4 illustrated in FIG. 12. In the second coil group 4, the winding end part 41B of the portion 41 included in the first stator 21 is connected to the winding end part 42B of the portion 42 included in the second stator 22, and becomes the other end part 43B of the second coil group 4 illustrated in FIG. 12. Thus, the portion 41 included in the first stator 21 of the second coil group 4 is electrically connected in parallel to the portion 42 included in the second stator 22. Therefore, in the second coil group 4, a direction of a current flow to the portion 41 included in the first stator 21 is the same as a direction of a current flow to the portion 42 included in the second stator 22 in the circumferential direction.

In the third coil group 5, the winding start part 51A of the portion 51 included in the first stator 21 is connected to the winding start part 52A of the portion 52 included in the second stator 22, and becomes one end part 53A of the third coil group 5 illustrated in FIG. 12. In the third coil group 5, the winding end part 51B of the portion 51 included in the first stator 21 is connected to the winding end part 52B of the portion 52 included in the second stator 22, and becomes the other end part 53B of the third coil group 5 illustrated in FIG. 12. Thus, the portion 51 included in the first stator 21 of the third coil group 5 is electrically connected in parallel to the portion 52 included in the second stator 22. Therefore, in the third coil group 5, a direction of a current flow to the portion 51 included in the first stator 21 is the same as a direction of a current flow to the portion 52 included in the second stator 22 in the circumferential direction.

In each coil group 3, 4, or 5, a direction of a current flow to the portion included in the second stator 22 is opposite to that in the first embodiment, and thus the winding direction (clockwise (cw) or counterclockwise (ccw)) of all the coils in the second stator 22 may be opposite to that in the first embodiment as necessary.

The first coil group 3 to the third coil group 5 are connected as described below. The other end part 33B of the first coil group 3 is connected to one end part 43A of the second coil group 4, and serves as a contact 13 of the delta connection. The other end part 43B of the second coil group 4 is connected to one end part 53A of the third coil group 5, and serves as a contact 14 of the delta connection. The other end part 53B of the third coil group 5 is connected to one end part 33A of the first coil group 3 to form a contact 15 of the delta connection.

The motor 1 according to the first modification has a winding to be easily applied and easily improves the motor characteristics for the same reason as the motor 1 according to the first embodiment. In the motor 1 according to the first modification, the number of magnetic poles of the permanent magnets in the rotor 6 is not limited, but the winding method in the motor 1 according to the first modification can be suitably combined with the rotor 6 having, for example, forty-two magnetic poles. However, the rotor 6 may have another number of magnetic poles.

### Second Modification

Hereinafter, a case (second modification) of electrically connecting the portion included in the first stator in parallel to the portion included in the second stator in each coil group in the second embodiment will be described. The motor according to the second modification has the same configuration as the motor 1000 according to the second embodiment except that the method of connecting the wires is different, and thus the motor according to the second modification is also referred to as the motor 1000 using the same reference numerals. Members and components having the same functions and configurations as the members and components of the second embodiment are given the same reference signs as the second embodiment, and detailed descriptions of the members and components will be omitted below. For the drawings, refer to mainly FIGS. 9 and 12.

In the second modification, the winding method of the first coil group 3, the second coil group 4, and the third coil group 5 is the same as that of the motor 1000 according to the second embodiment. In the second modification, as in the first modification, as illustrated in FIG. 12, a first coil group 3 forming the first phase (U phase), a second coil group 4 forming the second layer (V phase), and a third coil group 5 forming the third phase (W phase) form the delta connection.

In the first coil group 3, the winding start part 31A of the portion 31 included in the first stator 21 is connected to the winding end part 32A of the portion 32 included in the second stator 22, and becomes one end part 33A of the first coil group 3 illustrated in FIG. 12. In the first coil group 3, the winding end part 31B of the portion 31 included in the first stator 21 is connected to the winding start part 32B of the portion 32 included in the second stator 22, and becomes the other end part 33B of the first coil group 3 illustrated in FIG. 12. Accordingly, in the first coil group 3, the portion 31 included in the first stator 21 is electrically connected in parallel to the portion 32 included in the second stator 22. Therefore, in the first coil group 3, a direction of a current flow to the portion 31 included in the first stator 21 is the same as a direction of a current flow to the portion 32 included in the second stator 22 in the circumferential direction.

In the second coil group 4, the winding start part 41A of the portion 41 included in the first stator 21 is connected to the winding end part 42A of the portion 42 included in the second stator 22, and becomes one end part 43A of the second coil group 4 illustrated in FIG. 12. In the second coil group 4, the winding end part 41B of the portion 41 included in the first stator 21 is connected to the winding start part 42B of the portion 42 included in the second stator 22, and becomes the other end part 43B of the second coil group 4 illustrated in FIG. 12. Thus, the portion 41 included in the first stator 21 of the second coil group 4 is electrically connected in parallel to the portion 42 included in the second stator 22. Therefore, in the second coil group 4, a direction of a current flow to the portion 41 included in the first stator 21 is the same as a direction of a current flow to the portion 42 included in the second stator 22 in the circumferential direction.

In the third coil group 5, the winding start part 51A of the portion 51 included in the first stator 21 is connected to the winding end part 52A of the portion 52 included in the second stator 22, and becomes one end part 53A of the third coil group 5 illustrated in FIG. 12. In the third coil group 5, the winding end part 51B of the portion 51 included in the first stator 21 is connected to the winding start part 52B of the portion 52 included in the second stator 22, and becomes the other end part 53B of the third coil group 5 illustrated in FIG. 12. Thus, the portion 51 included in the first stator 21 of the third coil group 5 is electrically connected in parallel to the portion 52 included in the second stator 22. Therefore, in the third coil group 5, a direction of a current flow to the portion 51 included in the first stator 21 is the same as a direction of a current flow to the portion 52 included in the second stator 22 in the circumferential direction.

In each coil group 3, 4, or 5, a direction of a current flow to the portion included in the second stator 22 is opposite to that in the second embodiment, and thus the winding direction (clockwise (cw) or counterclockwise (ccw)) of all the coils in the second stator 22 may be opposite to that in the second embodiment as necessary.

The first coil group 3 to the third coil group 5 are connected as described below. The other end part 33B of the first coil group 3 is connected to one end part 43A of the second coil group 4, and serves as a contact 13 of the delta connection. The other end part 43B of the second coil group 4 is connected to one end part 53A of the third coil group 5, and serves as a contact 14 of the delta connection. The other end part 53B of the third coil group 5 is connected to one end part 33A of the first coil group 3 to form a contact 15 of the delta connection.

The motor 1000 according to the second modification has a winding to be easily applied and easily improves the motor characteristics for the same reason as the motor 1000 according to the second embodiment. In the motor 1000 according to the second modification, the number of magnetic poles of the permanent magnets in the rotor 6 is not limited, but the winding method in the motor 1000 according to the second modification can be suitably combined with the rotor 6 having, for example, forty magnetic poles. However, the rotor 6 may have another number of magnetic poles.

### Third Modification

Hereinafter, a case (third modification) of electrically connecting the portion included in the first stator in parallel to the portion included in the second stator in each coil group in the third embodiment will be described. The motor according to the third modification has the same configuration as the motor 2000 according to the third embodiment except that the method of connecting the wires is different, and thus the motor according to the third modification is also referred to as a motor 2000 using the same reference numerals. Members and components having the same functions and configurations as the members and components of the third embodiment are given the same reference signs of the third embodiment, and detailed descriptions of the members and components will be omitted below. For the drawings, refer to mainly FIGS. 11 and 12.

In the third modification, the winding method of the first coil group 3, the second coil group 4, and the third coil group 5 is the same as that of the motor 2000 according to the third embodiment. In the third modification, as in the first modification, as illustrated in FIG. 12, the first coil group 3 forming the first phase (U phase), the second coil group 4 forming the second layer (V phase), and the third coil group 5 forming the third phase (W phase) form the delta connection.

In the first coil group 3, the winding start part 31A of the portion 31 included in the first stator 2021 is connected to the winding end part 32A of the portion 32 included in the second stator 2022, and becomes one end part 33A of the first coil group 3 illustrated in FIG. 12. In the first coil group 3, the winding end part 31B of the portion 31 included in the first stator 2021 is connected to the winding start part 32B of the portion 32 included in the second stator 2022, and becomes the other end part 33B of the first coil group 3 illustrated in FIG. 12. Accordingly, the portion 31 included in the first stator 2021 in the first coil group 3 is electrically connected in parallel to the portion 32 included in the second stator 2022.

Therefore, in the first coil group 3, a direction of a current flow to the portion 31 included in the first stator 2021 is the same as a direction of a current flow to the portion 32 included in the second stator 2022 in the circumferential direction.

In the second coil group 4, the winding start part 41A of the portion 41 included in the first stator 2021 is connected to the winding end part 42A of the portion 42 included in the second stator 2022, and becomes one end part 43A of the second coil group 4 illustrated in FIG. 12. In the second coil group 4, the winding end part 41B of the portion 41 included in the first stator 2021 is connected to the winding start part 42B of the portion 42 included in the second stator 2022, and becomes the other end part 43B of the second coil group 4 illustrated in FIG. 12. Thus, the portion 41 included in the first stator 2021 of the second coil group 4 is electrically connected in parallel to the portion 42 included in the second stator 2022. Therefore, in the second coil group 4, a direction of a current flow to the portion 41 included in the first stator 2021 is the same as a direction of a current flow to the portion 42 included in the second stator 2022 in the circumferential direction.

In the third coil group 5, the winding start part 51A of the portion 51 included in the first stator 2021 is connected to the winding end part 52A of the portion 52 included in the second stator 2022, and becomes one end part 53A of the third coil group 5 illustrated in FIG. 12. In the third coil group 5, the winding end part 51B of the portion 51 included in the first stator 2021 is connected to the winding start part 52B of the portion 52 included in the second stator 2022, and becomes the other end part 53B of the third coil group 5 illustrated in FIG. 12. Thus, the portion 51 included in the first stator 2021 of the third coil group 5 is electrically connected in parallel to the portion 52 included in the second stator 2022.

Therefore, in the third coil group 5, a direction of a current flow to the portion 51 included in the first stator 2021 is the same as a direction of a current flow to the portion 52 included in the second stator 2022 in the circumferential direction.

In each coil group 3, 4, or 5, a direction of a current flow to the portion included in the second stator 2022 is opposite to that in the third embodiment, and thus the winding direction (clockwise (cw) or counterclockwise (ccw)) of all the coils in the second stator 2022 may be opposite to that in the third embodiment as necessary.

The first coil group 3 to the third coil group 5 are connected as described below. The other end part 33B of the first coil group 3 is connected to one end part 43A of the second coil group 4, and serves as a contact 13 of the delta connection. The other end part 43B of the second coil group 4 is connected to one end part 53A of the third coil group 5, and serves as a contact 14 of the delta connection. The other end part 53B of the third coil group 5 is connected to one end part 33A of the first coil group 3 to form a contact 15 of the delta connection.

The motor 2000 according to the third modification has a winding to be easily applied and easily improves motor characteristics for the same reason as the motor 2000 according to the third embodiment. In the motor 2000 according to the third modification, the number of magnetic poles of the permanent magnets in the rotor 6 is not limited, but the winding method in the motor 2000 according to the third modification can be suitably combined with the rotor 6 having, for example, twenty-eight magnetic poles. However, the rotor 6 may have another number of magnetic poles.

Although the motor according to the present invention has been described with reference to the preferred embodiments and modifications, the rotating device according to the present invention is not limited to the configurations of the above-described embodiments and modifications. For example, in the above embodiments and the modifications, the motor 1, 1000, or 2000 is an outer-rotor type three-phase brushless DC motor, the motor of the present invention may be another motor. For example, the motor of the present invention may be an inner-rotor type motor.

In the above embodiment and modifications, the first coil group 3, the second coil group 4, and the third coil group 5 of the motor 1, 1000, or 2000 form the delta connection, but the coil groups of the motor of the present invention may form the delta connection (Y-connection).

In the above embodiments and modifications, the motor 1, 1000, or 2000 includes the first stator 21 or 2021 and the second stator 22 or 2022, but the motor of the present invention may include three or more stators as necessary.

In the first embodiment and the first modification, the first coil group 3, the second coil group 4, and the third coil group 5 are formed by winding the wire around the plurality of teeth 212 or 222 sequentially toward the first direction A of the circumferential direction. However, the motor of the present invention may use any direction of winding the wire to form each coil group, and for example, all the coil groups may be formed in a direction opposite to that of the above embodiment, or some of the coil groups may be formed in the first direction A, and the other coil groups may be formed in the second direction B.

In addition, the motor according to the present invention can be appropriately modified and the shapes, the dimensions, and the combinations of the various configurations can be modified, by a person skilled in the art according to previously known knowledge. Such modifications are of course included in the scope of the present invention as long as these modifications still include the configurations of the present invention.

### REFERENCE SIGNS LIST

1, 1000, 2000 Motor, 2, 2002 Stator, 21, 2021 First stator, 22, 2022 Second stator, 3 First coil group, 4 Second coil group, 5 Third coil group, 6 Rotor.

1. A motor, comprising:
a rotor; and
a first stator and a second stator overlapping in a rotation axis direction of the rotor, wherein
the first stator and the second stator include a first coil group forming a first phase, and
in the first coil group, a portion included in the first stator is electrically connected in series to a portion included in the second stator.

2. The motor according to claim 1, wherein
the first stator and the second stator include a second coil group forming a second phase, and
in the second coil group, a portion included in the first stator is electrically connected in series to a portion included in the second stator.

3. The motor according to claim 2, wherein
the first stator and the second stator each include a third coil group forming a third phase, and
in the third coil group, a portion included in the first stator is electrically connected in series to a portion included in the second stator.

4. The motor according to claim 3, wherein the first coil group, the second coil group, and the third coil group form a delta connection.

5. The motor according to claim 3, wherein
in the first coil group, the second coil group, and the third coil group, a plurality of coils forming one coil group are electrically connected in series.
